(19) United States
(12) Patent Application Publication
(10) Pub. No.: US 2020/0215988 A1
(43) Pub. Date: Jul. 9, 2020

(54) LIGHTWEIGHT STRUCTURAL MODULE ON THE ROOF OF A VEHICLE

(71) Applicant: Valeo North America, Inc., Auburn Hills, MI (US)

(72) Inventors: Clarence Jackson, Auburn Hills, MI (US); Satish Nadella, Auburn Hills, MI (US); Peter Brookes, Auburn Hills, MI (US)

(73) Assignee: Valeo North America, Inc., Auburn Hills, MI (US)

(21) Appl. No.: 16/709,236

(22) Filed: Dec. 10, 2019

Related U.S. Application Data
(60) Provisional application No. 62/789,318, filed on Jan. 7, 2019.

(51) Int. Cl. B60R 11/02; G01S 7/481

(52) U.S. Cl. CPC B60R 11/02; B60R 2011/004; G01S 7/4813

(57) ABSTRACT

A sensor pod module, that attaches to a vehicle, includes: a structural base, being adapted to a contour of a surface of the vehicle, including a first connector and a vehicle connector; a sensor housing including a second connector that form fits with the first connector; and a plurality of sensors disposed within the sensor housing. The structural base secures to the vehicle with the vehicle connector. The sensor housing interchangeably secures to the structural base by form fitting the second connector and first connector together.

### BACKGROUND

Autonomous vehicles have gained popularity in recent years, particularly in automobiles. To navigate roadways autonomously, an assortment of detectors or sensors are used to acquire and analyze information about the roadway. Conventional autonomous vehicles mount multiple sensors around the vehicle or on the roof of the vehicle to collect information about the surrounding environment.

### SUMMARY

One or more embodiments of the invention are directed to a sensor pod module that attaches to a vehicle and that includes: a structural base including a first connector and a vehicle connector that is adapted to a contour of the vehicle; a sensor housing including a second connector that form fits with the first connector; and a plurality of sensors disposed within the sensor housing. The structural base secures to the vehicle with the vehicle connector. The sensor housing interchangeably secures to the structural base by form fitting the second connector and first connector together.

One or more embodiments of the invention are directed to a vehicle including a sensor pod module that attaches to a vehicle and that includes: a structural base including a first connector and a vehicle connector that is adapted to a contour of the vehicle; a sensor housing including a second connector that form fits with the first connector; and a plurality of sensors disposed within the sensor housing. The structural base secures to the vehicle with the vehicle connector. The sensor housing interchangeably secures to the structural base by form fitting the second connector and first connector together.

Other aspects and advantages of one or more embodiments disclosed herein will be apparent from the following description and the appended claims.

### BRIEF DESCRIPTION OF DRAWINGS

FIG. 1 shows a lightweight AV sensor pod module in accordance with one or more embodiments of the invention installed on a vehicle.

FIG. 2 shows a lightweight AV sensor pod module in accordance with one or more embodiments of the invention installed on a vehicle.

FIG. 3 shows a lightweight AV sensor pod module in accordance with one or more embodiments of the invention installed on a vehicle.

FIG. 4 shows a lightweight AV sensor pod module in accordance with one or more embodiments of the invention.

FIG. 5 shows a lightweight AV sensor pod module in accordance with one or more embodiments of the invention installed on a vehicle.

FIG. 6 shows a structural base in accordance with one or more embodiments of the invention.

FIG. 7 shows an enlarged view of a structural base in accordance with one or more embodiments of the invention.

FIG. 8 shows an enlarged view of a structural base in accordance with one or more embodiments of the invention.

FIG. 9 shows a cross sectional view of a structural base in accordance with one or more embodiments of the invention.

FIGS. 10A-J show examples of a first and second mount in accordance with one or more embodiments of the invention.

FIGS. 11A-E show examples of a first and second mount in accordance with one or more embodiments of the invention.

FIG. 12 shows a structural base in accordance with one or more embodiments of the invention.

FIG. 13 shows a sensor housing in accordance with one or more embodiments of the invention.

FIG. 14 shows a sensor housing in accordance with one or more embodiments of the invention.

FIG. 15 shows a sensor housing in accordance with one or more embodiments of the invention.

FIG. 16 shows an enlarged perspective view of a sensor housing in accordance with one or more embodiments of the invention.

FIG. 17 shows a sensor shell in accordance with one or more embodiments of the invention.

FIG. 18 shows a sensor frame in accordance with one or more embodiments of the invention.

FIG. 19 shows a sensor frame in accordance with one or more embodiments of the invention.

FIG. 20 shows a sensor frame in accordance with one or more embodiments of the invention.

### DETAILED DESCRIPTION

Specific embodiments of the invention will now be described in detail with reference to the accompanying figures Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create a particular ordering of the elements nor to limit any element to being only a single element unless expressly disclosed, such as by the use of the terms “before,” “after,” “single,” and other such terminology. Rather the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “a horizontal beam” includes reference to one or more of such beams.

Terms like “approximately,” “substantially,” etc., mean that the recited characteristic, parameter, or value need not be achieved exactly, but that deviations or variations, including for example, tolerances, measurement error, measurement accuracy limitations and other factors known to those of ordinary skill in the art, may occur in amounts that do not preclude the effect of the characteristic was intended to provide.

In general, embodiments of the invention provide a lightweight autonomous vehicle (AV) sensor pod module comprising a sensor housing that is interchangeably removable from a structural base.

In one or more embodiments, a lightweight material such as carbon fiber or Organo sheet technology may be used to decrease the overall weight of the AV sensor system, resulting in a lightweight AV sensor pod module.

In one or more embodiments, the autonomous vehicle may not be entirely autonomous. In one or more embodiments, the lightweight sensor pod module may be installed on a vehicle that is fully-controlled, partially-controlled, or not-controlled by a driver. In one or more embodiments, the vehicle may be any type of vehicle and is not limited to motor vehicles (e.g., plane, boat). In one or more embodiments, the vehicle may be a stationary object.

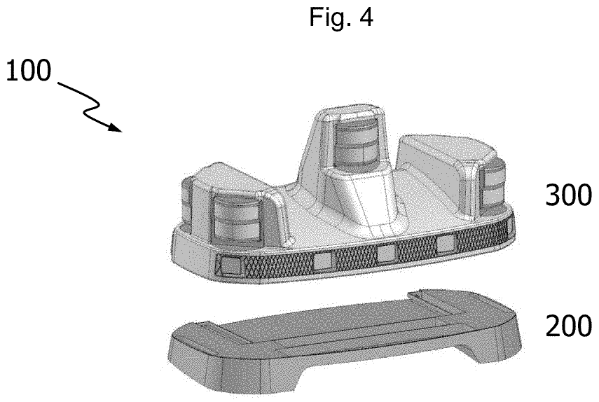

In one or more embodiments, the lightweight AV sensor pod module (100) comprises two interchangeably removable components: a structural base (200, as shown in FIG. 4) and a sensor housing (300, FIG. 4). In other words, the cooperating sensor housing (300) may be installed on, removed from, or exchanged between different structural bases (200) quickly and without modifications. In one more embodiments, a single sensor housing (300) can be deployed on a wide variety of different vehicles types, each with a structural base (200) that is customized to each different vehicle type. The structural base (200) and the sensor housing (300) are discussed in detail below.

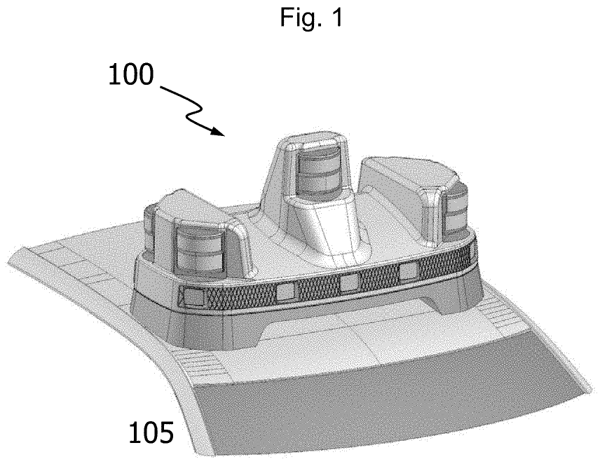

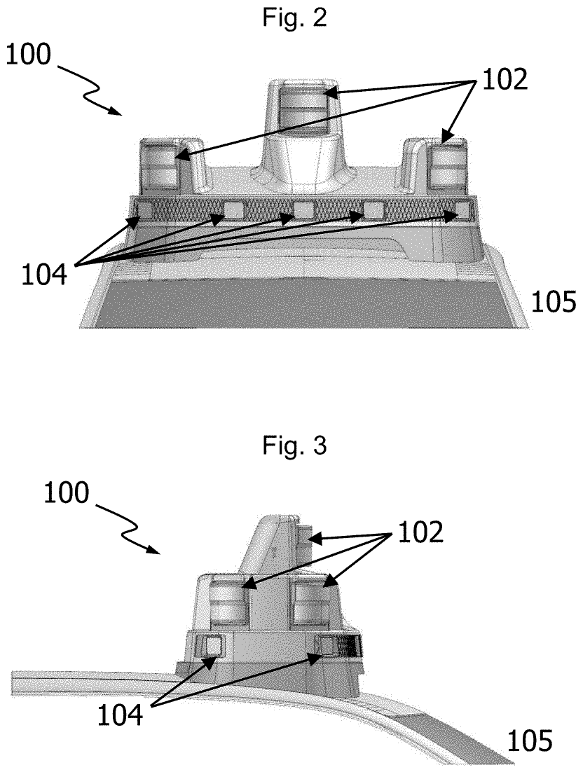

FIGS. 1-3 show a lightweight AV sensor pod module (100) in accordance with one or more embodiments of the invention installed on a surface of an autonomous vehicle (105).

The lightweight AV sensor pod module (100) has a plurality of sensors, including, for example, light detection and ranging (LIDAR) sensors (102) and camera sensors (104). Any number of sensors suitable for the size of the AV sensor pod module (100) may be installed on the module. The sensors may be distributed around the lightweight AV sensor pod module (100) to acquire data from the entire surroundings of the autonomous vehicle. The sensors may be mounted a predetermined distance above the surface of the autonomous vehicle (105) to provide a clear view of the surroundings of the autonomous vehicle. By positioning the sensors a predetermined distance apart from the surface of the autonomous vehicle (105), the sensors can observe surrounding regions both close to and far from the autonomous vehicle without being obstructed by the surface of the autonomous vehicle (105). As shown in FIGS. 1-3, the surface may be a contoured surface of the autonomous vehicle (105), such as the roof of the vehicle (105). However, embodiments of the invention are not limited to the roof of a vehicle, and those skilled in the art will appreciate that the surface may be any other appropriate surface of the autonomous vehicle (105) (e.g., trunk, hood, side panel, top surface) that provides a suitable position to observe the surrounding environment.

In one or more embodiments, the sensors may be symmetrically distributed around the lightweight AV sensor pod module (100). In one or more embodiments, the sensors may be asymmetrically distributed on the lightweight AV sensor pod module (100) to collect more information from a predetermined section of the surroundings of the autonomous vehicle. For example, a larger number of camera sensors (104) may be oriented toward a front side of the autonomous vehicle (105), compared to a back side, to collect more information about the surrounding environment in front of the autonomous vehicle (105).

In one or more embodiments, the sensors may be disposed on the AV sensor pod module (100) at different predetermined distances from the surface of the autonomous vehicle (105). As shown in FIGS. 1-3, multiple LIDAR sensors (102) may be used at a first predetermined distance from the roof of the autonomous vehicle (105) to collect information from the surrounding environment. One or more additional LIDAR sensors (102) may be disposed at a second predetermined distance that is greater that the first predetermined distance to collect a different type of information from the surrounding environment. For example, the one or more additional LIDAR sensors (102) may collection information from a region closer to the autonomous vehicle (105), compared to the LIDAR sensors (102) at the first predetermined distance, because the roof does not obstruct the field of view as much.

In one or more embodiments, the lightweight AV sensor pod module (100) may further comprise equipment to support the plurality of sensors, including, for example, an electrical connector, a signal cable, a power conduit, a power cable, a power supply, a global position system (GPS) sensor, an inertial measurement unit (IMU), a cooling fan, an exhaust blower, a temperature probe, a light sensor, a lighting system, a reflector, an indicator light, a sensor display, a data display, a sensor cleaning apparatus, a cleaning fluid dispenser, a cleaning fluid supply line, a cleaning fluid reservoir, and the like.

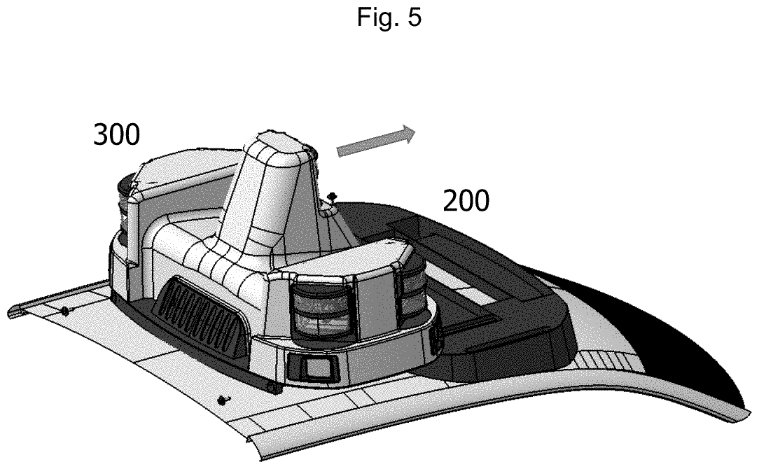

FIGS. 4-5 show a lightweight AV sensor pod module (100) in accordance with one or more embodiments of the invention.

The lightweight AV sensor pod module (100) comprises a structural base (200) that rigidly attaches to a surface (e.g., the roof) of the autonomous vehicle (105). Alternatively, the surface may be a frame of the autonomous vehicle (105) or a rack on the roof of the autonomous vehicle (105). However, the surface is not particularly limited to these configurations. Any appropriate surface or plurality of surfaces of the autonomous vehicle (105) that the structural base (200) attaches to may be used.

The structural base (200) may be permanently attached the surface of the autonomous vehicle (105) or may be removable. More specifically, the lightweight AV sensor pod module (100) may attach to an interchangeable structural mounting base (200). The structural mounting base design is modular and intended to be able to be adapted to any vehicle platform. In general, the structural base (200) provides a rigid connection between the sensor housing (300) and the autonomous vehicle (105). A rigid connection is defined as an attachment that is sufficiently stiff to prevent vibrations or perturbations of the plurality of sensors that may disrupt acquisition and analysis of data of the surrounding environment during operation of the autonomous vehicle (105).

Those skilled in the art will appreciate that that lightweight AV sensor pod module (100) that carries the electronics is intended to remain the same across all vehicle types and only the structural mounting base (200) may be modified to meet the contour of the different vehicle surface profiles.

In one or more embodiments, the shape of a first side of the structural base (200) is adapted to (i.e., form fitted to) a contour of the autonomous vehicle (105). Furthermore, the shape of a second side of the structural base (200) is predetermined. In other words, the first side, for example a bottom side, of two structural bases (200) may each be designed to conform to the surface, the roof line, curvature, or structural frame of two different autonomous vehicles (105). The second side, for example a top side, of the two structural bases (200) are predetermined and substantially identical such that any cooperating sensor housing (300) may be interchangeably installed on and removed from either of the two structural bases (200).

In general, the first side of different structural bases (200) can be adapted to different vehicle roof lines (or contours) of a variety of different vehicles while the second side of the different structural bases (200) are substantially identical. That is, the predetermined second side of the different structural bases (200) are able to connect to a single sensor housing (300) in the substantially identical manner. As shown in the non-limiting example of FIG. 5, one or more embodiments of the sensor housing (300) may connect to the top side of the structural base (200) by horizontally sliding onto the structural base (200). Other embodiments of the interchangeable design of the second side of the structural base (200) are discussed in detail below.

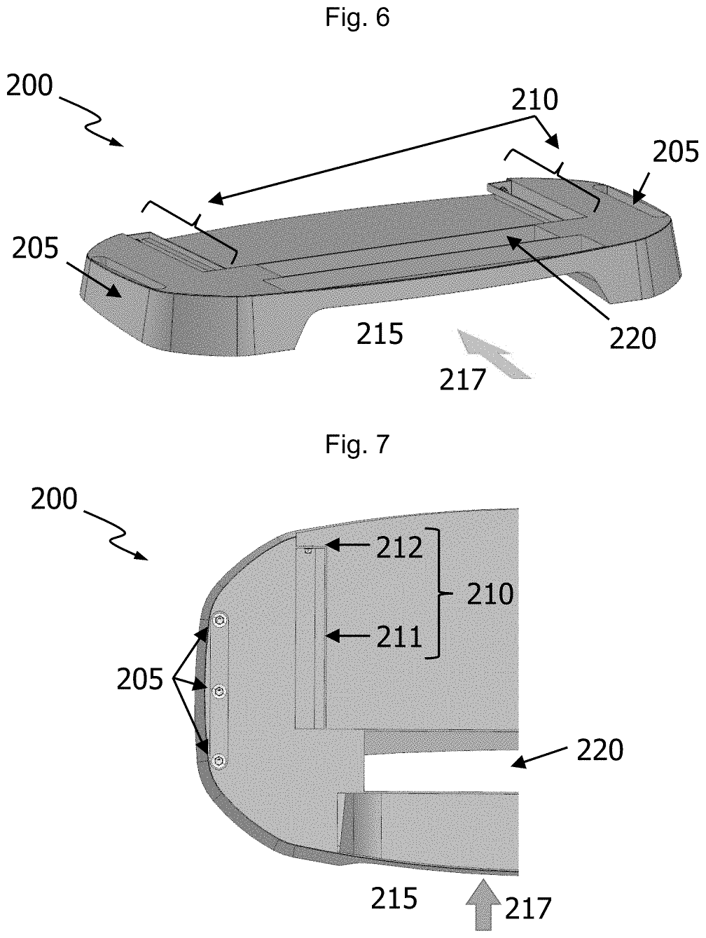

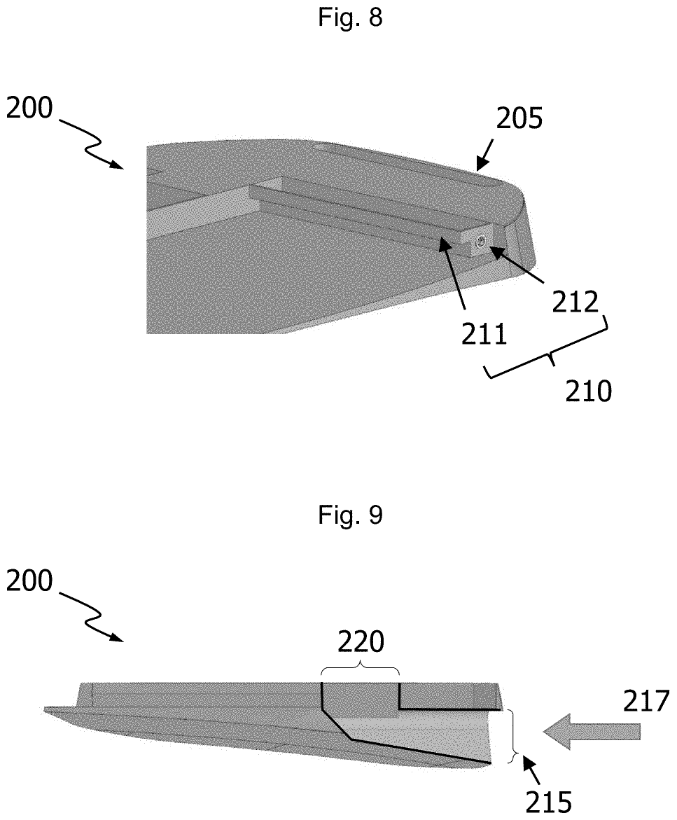

FIGS. 6-9 show a structural base (200) in accordance with one or more embodiments of the invention.

As shown in FIGS. 6-7, the structural base (200) comprises a vehicle connector (205) that provides the rigid connection between the structural base (200) and the autonomous vehicle (105). The vehicle connector (205) is adapted to (i.e., form fitted to) a contour of a surface (e.g., the roof) of the autonomous vehicle (105). In one or more embodiments, the vehicle connector (205) may be a plurality of holes and bolts that cooperate with the surface of the autonomous vehicle (105). For example, the bolts may be M6 bolts disposed in vertically oriented holes of the structural base (200) to connect with M6 rivet nuts disposed in the surface of the autonomous vehicle (105). However, the invention is not particularly limited to this type of fastener. Any appropriate fastener (e.g., screw, clamp, locking mechanism) that secures the structural base (200) to the autonomous vehicle (105) may be used.

In addition, as shown in FIGS. 6-7 and 9, the structural base (200) may comprise an air intake (215) and an internal air duct (220). The air intake (215) may be delimited by only the shape of the structural base (200) (e.g., an orifice in a wall of the structural base (200)) or may delimited by a combination of the surface of the autonomous vehicle (105) and the shape of the structural base (200). When the structural base (200) is connected to a sensor housing (300), the air intake (215) directs air flow (217) through the internal air duct (220), disposed in the second side of the structural base (200), and into the sensor housing (300). The air flow (217) may be used to cool, filter, or cycle air within the sensor housing (300).

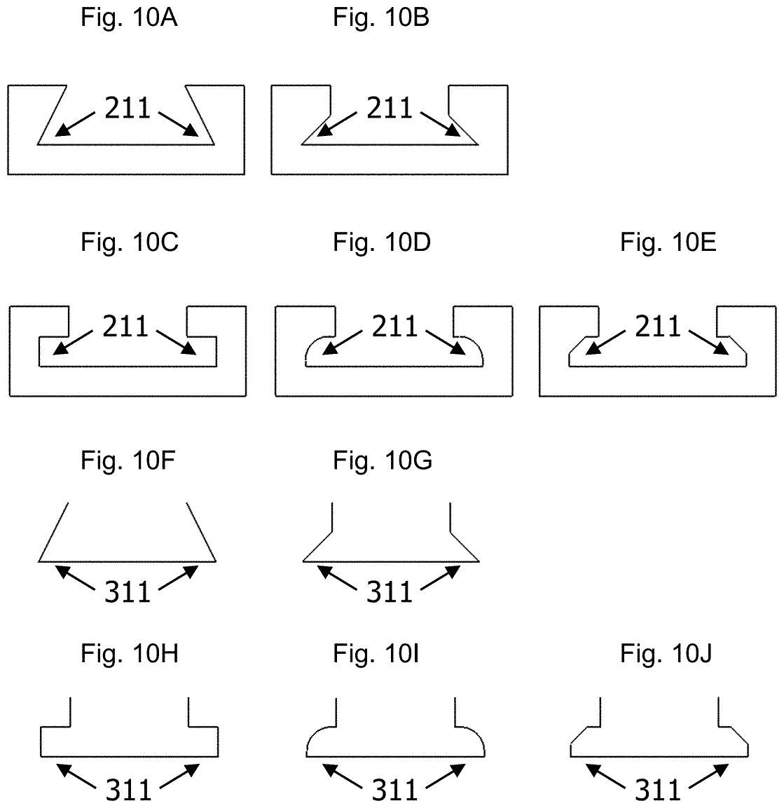

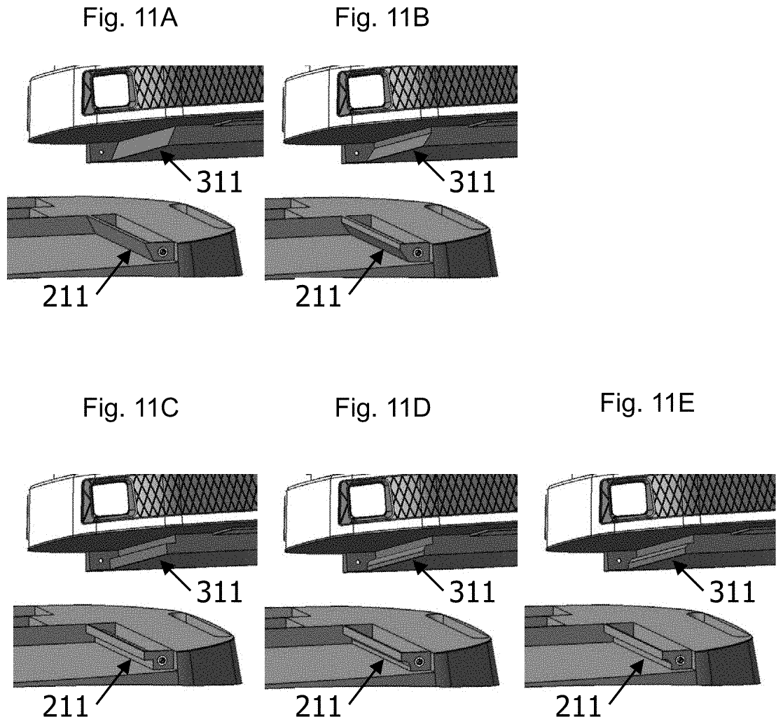

As shown in FIGS. 6-8, the structural base (200) further comprises a first connector (210) that provides a rigid connection between the structural base (200) and the sensor housing (300). In one or more embodiments, the first connector (210) may comprise a first mount (211) (e.g., a first dovetail slot, a first T-slot, etc.) that cooperates with a corresponding (i.e., respective) second mount (311) on the sensor housing (300) such that the sensor housing (300) can be interchangeably installed on and removed from the structural base (200). FIGS. 10A-B, and 11A-B show various examples of a dovetail design for first mount (211), but the invention is not particularly limited to these dovetail geometries. FIGS. 10C-E, and 11C-E show various examples of a T-slot design for first mount (211), but the invention is not particularly limited to these T-slot geometries. In one or more embodiments, first connector (210) further comprises a first locking mount (212) that may comprise an M6 rivet nut that cooperates with a corresponding second locking mount (312) (e.g., an M6 bolt) on the sensor housing (300). However, the invention is not particularly limited to these types of connectors. Any appropriate connector geometry that allows for the sensor housing (300) to be interchangeably installed on and removed from the structural base (200) may be used.

In one or more embodiments, the first mount (211) and first locking mount (212) may be horizontally oriented such that the sensor housing (300) slides forward (e.g., in a horizontal direction toward the front of the autonomous vehicle (105)) to mount and lock onto the structural base (200). However, the first mount (211) and first locking mount (212) are not particularly limited to this orientation. For example, the first mount (211) and first locking mount (212) may be horizontally or vertically oriented to facilitate loading from the front, side, or top of the autonomous vehicle (105). Alternatively, the first mount (211) and first locking mount (212) may be oriented at an angle to facilitate loading from the any direction relative to the autonomous vehicle (105).

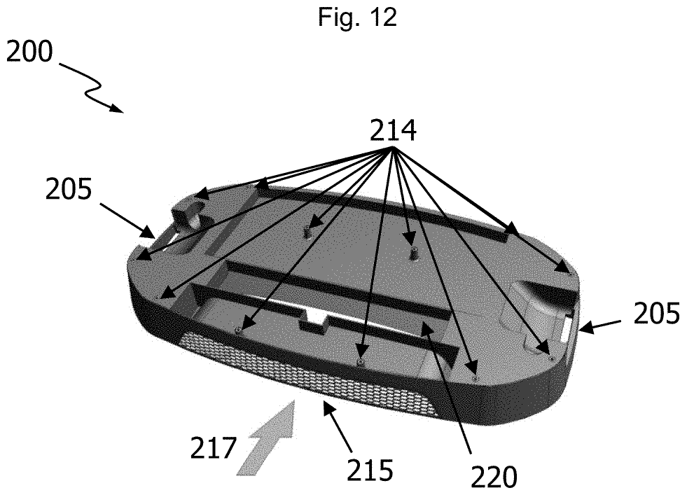

For example, FIG. 12 shows a structural base (200) in accordance with one or more embodiments of the invention. The first connector (210) may comprise a plurality of first fastening points (214) that cooperate with a sensor housing (300) such that the sensor housing (300) can be interchangeably installed and removed from the structural base (200). In one or more embodiments, a first fastening point of the plurality of first fastening points may be a shaped protrusion that cooperates with a complementary second fastening point on the sensor housing (300). Each first fastening point (214) may comprise an M6 rivet nut that cooperates with a corresponding second fastening point (e.g., an M6 bolt) on the sensor housing (300). However, the invention is not particularly limited to this type of fastener. Any appropriate pair of cooperating fastenings (e.g., a locking key and cooperating slot, spring loaded latch and cooperating locking tab) that allows for the sensor housing (300) to be interchangeably installed on and removed from the structural base (200) may be used.

In one or more embodiments, the structural base (200) is formed from carbon fiber material that reduces weight and provides the stiffness and rigidity to form a rigid connection to both the surface of the autonomous vehicle (105) and the sensor housing (300). In one or more embodiments, the structural base (200) is formed from Organo sheet technology. Organo sheet (or organic sheet) technology is defined as a hybrid material comprising a fabric that is embedded in a thermoplastic matrix with a predetermined orientation. The fabric may comprise carbon fiber, glass fiber, Kevlar(™), or a mixture of multiple fibers, but the fabric is not particularly limited to these fibers. The fabric may be woven or laid, but is not particularly limited to these constructs. The thermoplastic matrix may comprise polyamide or any other appropriate structural matrix that supports the embedded fabric. In one or more embodiments, the organic sheet may be semi-finished. Alternatively, the organic sheet may be bonded or reinforced with additional structures (e.g., thermoplastic or metal supports) to further improve the physical properties (e.g., stiffness, strength). In one or more embodiments, the organic sheets may be shaped by thermoforming, injection molding, or any other appropriate method of shaping.

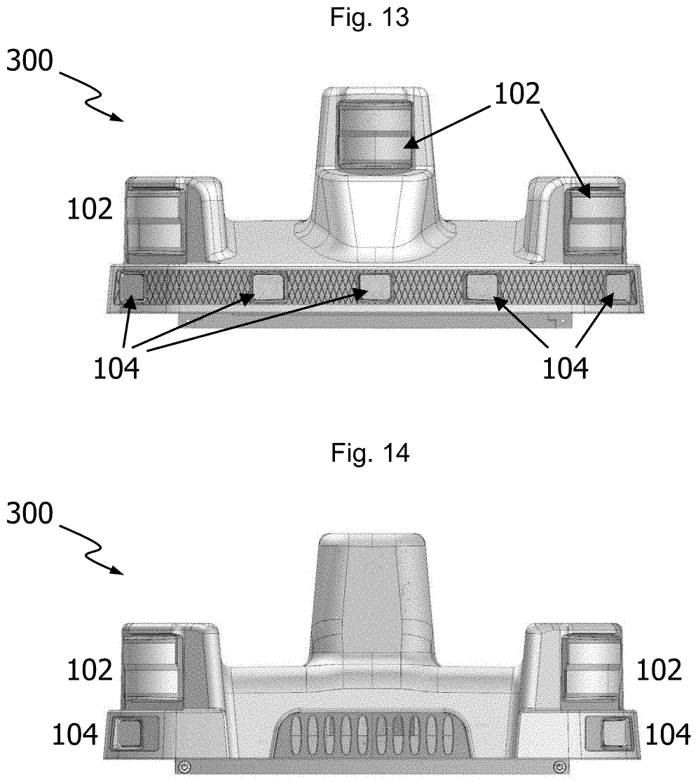

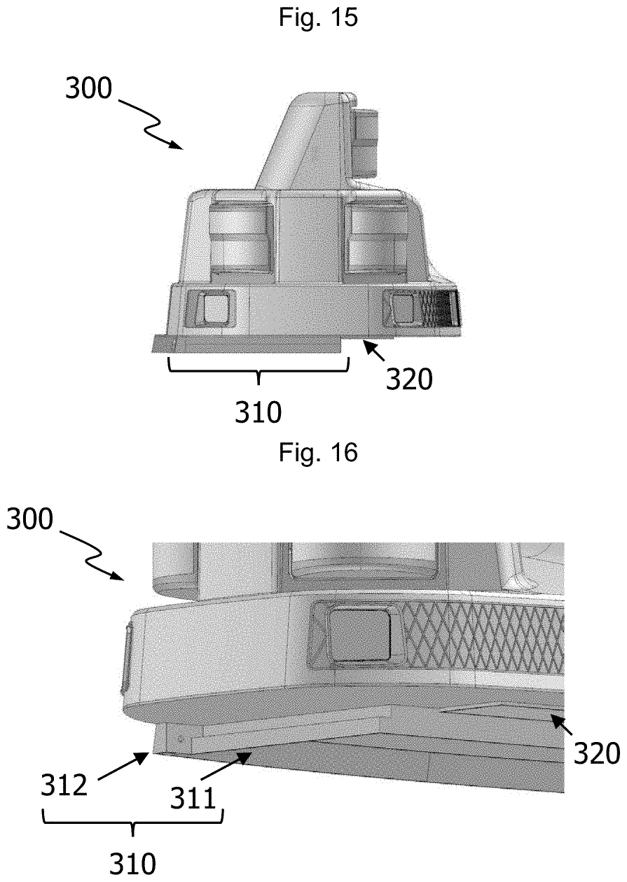

FIGS. 13-16 show a sensor housing (300) in accordance with one or more embodiments of the invention.

The sensor housing (300) retains the plurality of sensors (e.g., a LIDAR sensor (102) and a camera sensor (104)). Furthermore, the sensor housing (300) comprises a second connector (310) that provides a rigid connection between the structural base (200) and the sensor housing (300).

In one or more embodiments, the second connector (310) may comprise a second mount (311) (e.g., a second dovetail slot, a second T-slot, etc.) that cooperates (e.g., form fits) with the first mount (211) on the structural base (200) such that the sensor housing (300) can be interchangeably installed on and removed from the structural base (200). FIGS. 10F-G, and 11A-B show various examples of a dovetail design for second mount (311), but the invention is not particularly limited to these dovetail geometries. FIGS. 10H-J, and 11C-E show various examples of a T-slot design for second mount (311), but the invention is not particularly limited to these T-slot geometries. In one or more embodiments, the second connector (310) further comprises a second locking mount (312) that may comprise an M6 bolt that cooperates with the first locking mount (212) (e.g., an M6 rivet nut) on the structural base (200). However, the invention is not particularly limited to these types of connectors. Any appropriate connector geometry that allows for the sensor housing (300) to be interchangeably installed on and removed from the structural base (200) may be used.

Furthermore, in one or more embodiments, the second mount (311) and second locking mount (312) may be horizontally oriented such that the sensor housing (300) slides forward (e.g., in a horizontal direction toward the front of the autonomous vehicle (105)) to mount and lock onto the structural base (200). However, the second mount (311) and second locking mount (312) are not particularly limited to this orientation. For example, the second mount (311) and second locking mount (312) may be horizontally or vertically oriented to facilitate loading from the front, side, or top of the autonomous vehicle (105). Alternatively, the second mount (311) and second locking mount (312) may be oriented at an angle to facilitate loading from the any direction relative to the autonomous vehicle (105).

For example, in accordance with the non-limiting example of FIG. 12, in one or more embodiments, the second connector (310) may comprise a plurality of second fastening points that cooperate with a first connector (210) on a structural base (200) such that the sensor housing (300) can be interchangeably installed on and removed from the structural base (200). In one or more embodiments, a second fastening point of the plurality of second fastening points may be a shaped recession that cooperates with a corresponding first fastening point (214) on the structural base (200). The second fastening point may comprise an M6 bolt that cooperates with a corresponding first fastening point (214) (e.g., an M6 rivet nut) on the structural base (200). However, the invention is not particularly limited to this type of fastener. Any appropriate fastener (e.g., screw, clamp, locking mechanism) that allows for the sensor housing (300) to be interchangeably installed on and removed from the structural base (200) may be used.

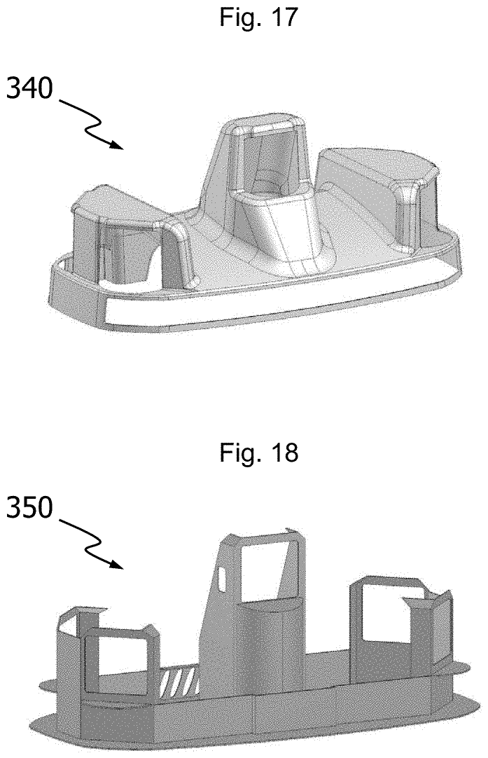

FIG. 17 shows a sensor shell (340) in accordance with one or more embodiments of the invention.

The sensor housing (300) comprises a sensor shell (340) that covers a sensor frame (350), shown in FIG. 18, that retains the plurality of sensors (e.g., LIDAR sensors (102) and LID camera sensors (104)). The sensor shell (340) may comprise a plurality of holes that correspond with the plurality of sensors. Furthermore, the plurality of holes may accommodate other equipment that supports the plurality of sensors (e.g., electrical connectors, signal cables, power conduits, air flow intake ports and exhaust ports, light sensors, displays, indicators, etc.).

The shape of the sensor shell (340) may guide air flow inside and/or around the sensor housing (300) to reduce vibrations of the plurality of sensors. In other words, the aerodynamic properties of the sensor shell (340) may prevent the sensor housing (300), and therefore the plurality of sensors therein, from vibrating excessively.

In one or more embodiments, the sensor shell (340) is formed from carbon fiber material that reduces weight and provides the stiffness and rigidity to form a rigid structure that protects the plurality of sensors. A rigid structure is defined as a structure that is sufficiently stiff to prevent vibrations or perturbations of the plurality of sensors that may disrupt acquisition and analysis of data of the surrounding environment during operation of the autonomous vehicle. In one or more embodiments, the sensor shell (340) may be formed from Organo sheet technology. However, the sensor shell (340) may be formed of any appropriate structural material that provides a rigid structure.

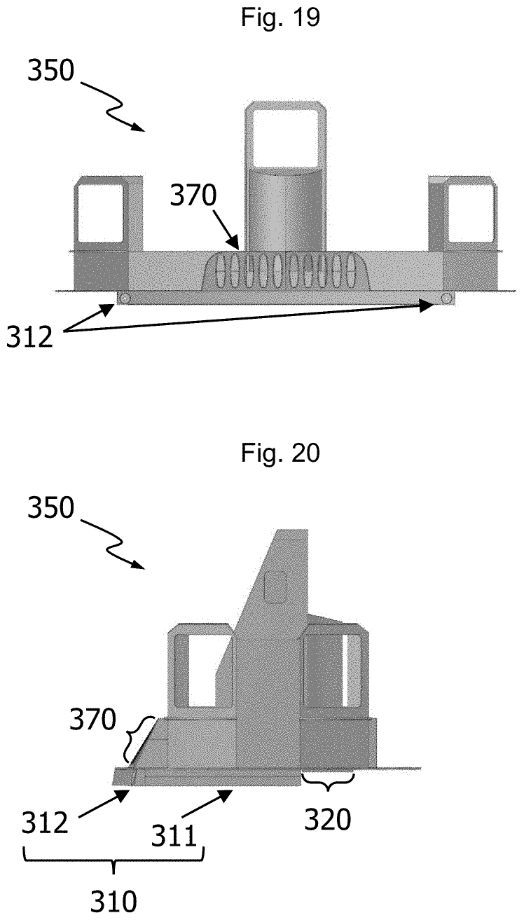

FIGS. 18-20 show a sensor frame (350) in accordance with one or more embodiments of the invention.

The sensor frame (350) may comprise a series of mounting points or holes that retain with the plurality of sensors disposed in the sensor housing (300). In one or more embodiments, the plurality of sensors are retained by cooperating M6 blots and M6 rivet nuts. However, any appropriate fastener (e.g., screw, clamp, locking mechanism, adhesive) that secures the plurality of sensors to the sensor frame (350) may be used.

The sensor frame (350) may further comprise internal plates and supports that reduce vibrations of the plurality of sensors. For example, a plurality of internal plates may be disposed on a base plate of the sensor frame (350) such that the internal plates are oriented perpendicularly to the plane of the base plate. The internal plates may further comprise the mounting points or holes to retain the plurality of sensors. Furthermore, the internal plates may be disposed to abut the sensor shell (340) to provide further structural support to the sensor housing (300).

In one or more embodiments, the sensor frame (350) is formed from carbon fiber material that reduces weight and provides the stiffness and rigidity to form a rigid structure that retains the plurality of sensors. In one or more embodiments, the sensor frame (350) may be formed from Organo sheet technology. However, the sensor frame (350) may be formed of any appropriate structural material that provides a rigid structure.

In one or more embodiments, the sensor frame (350) comprises an internal air intake (320) and an external air outlet (370). When the structural base (200) is connected to a sensor housing (300), the internal air intake (320) cooperates with the internal air duct (220) of the structural base (200) to accept air flow (217). The external air outlet (370) allows air to exit the sensor housing (300). In one or more embodiments, an exhaust blower and/or a cooling fan are disposed on the sensor frame to direct and control the flow of air from air intake (320) and out of the external air outlet (370).

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A sensor pod module that attaches to a vehicle, the sensor pod module comprising:
a structural base comprising a first connector and a vehicle connector, the structural base being adapted to a contour of a surface of the vehicle;
a sensor housing comprising a second connector that form fits with the first connector; and
a plurality of sensors disposed within the sensor housing,
wherein the structural base secures to the vehicle with the vehicle connector, and
wherein the sensor housing interchangeably secures to the structural base by form fitting the second connector and first connector together.

2. The sensor pod module of claim 1, wherein
the first connector comprises:
a first mount that includes a first dovetail slot or a first T-slot; and
a first locking mount that includes a rivet nut, and
the second connector comprises:
a second mount that includes a second dovetail slot that cooperates with the first dovetail slot or a second T-slot that cooperates with the first T-slot, and
the second locking mount that includes a bolt that cooperates with the rivet nut of the first locking mount.

3. The sensor pod module of claim 2, wherein
the first and second dovetail slots or the first and second T-slots oriented in a horizontal direction of the vehicle, and
the sensor housing secures to the structural base by sliding in the horizontal direction to form fit the first and second connectors together.

4. The sensor pod module of claim 1, wherein
the first connector comprises a plurality of first fastening points that each include a rivet nut,
the second connector comprises a plurality of second fastening points that each include a bolt that cooperates with the rivet nuts of the plurality of first fastening points.

5. The sensor pod module of claim 1, wherein
the vehicle connector is disposed on a first side of the structural base that is capable of being adapted to a contour of a surface of a plurality of different vehicles; and
the first connector is disposed on a second side of the structural base that is predetermined and independent of the contour of the surface of the plurality of different vehicles.

6. The sensor pod module of claim 1, wherein
the structural base comprises:
an air intake, and
an internal air duct that directs air flow from the air intake into the sensor housing, and
the sensor housing further comprises:
an internal air intake that receives air flow from the internal air duct; and
an external air outlet that allows air flow to exit the sensor housing.

7. The sensor pod module of claim 1, wherein
the sensor housing further comprises:
a sensor frame including a plurality of mounting points retaining the plurality of sensors; and
a sensor shell that covers the sensor frame and defines an exterior shape of the sensor housing, wherein
the sensor frame has a rigid structure that prevents movements of the plurality of sensors that disrupt acquisition and analysis of data of a surrounding environment during operation of the vehicle.

8. The sensor pod module of claim 7, wherein the sensor frame or the sensor shell is formed from Organo sheet technology.

9. The sensor pod module of claim 1, wherein the structural base is formed from Organo sheet technology.

10. A vehicle comprising:
a sensor pod module comprising:
a structural base comprising a first connector and a vehicle connector, the structural base being adapted to a contour of a surface of the vehicle;
a sensor housing comprising a second connector that form fits with the first connector; and
a plurality of sensors disposed within the sensor housing, wherein
the structural base secures to the vehicle with the vehicle connector, and
the sensor housing interchangeably secures to the structural base by form fitting the second connector and first connector together.

11. The vehicle of claim 10, wherein
the first connector comprises:
a first mount that includes a first dovetail slot or a first T-slot; and
a first locking mount that includes a rivet nut, and the second connector comprises:
a second mount that includes a second dovetail slot that cooperates with the first dovetail slot or a second T-slot that cooperates with the first T-slot, and
the second locking mount that includes a bolt that cooperates with the rivet nut of the first locking mount.

12. The vehicle of claim 11, wherein
the first and second dovetail slots or the first and second T-slots oriented in a horizontal direction of the vehicle, and
the sensor housing secures to the structural base by sliding in the horizontal direction to form fit the first and second connectors together.

13. The vehicle of claim 10, wherein
the first connector comprises a plurality of first fastening points that each include a rivet nut,
the second connector comprises a plurality of second fastening points that each include a bolt that cooperates with the rivet nuts of the plurality of first fastening points.

14. The vehicle of claim 10, wherein
the vehicle connector is disposed on a first side of the structural base that is capable of being adapted to a contour of a surface of a plurality of different vehicles; and
the first connector is disposed on a second side of the structural base that is predetermined and independent of the contour of the surface of the plurality of different vehicles.

15. The vehicle of claim 10, wherein
the structural base comprises:
an air intake; and
an internal air duct that directs air flow from the air intake into the sensor housing, and
the sensor housing further comprises:
an internal air intake that receives air flow from the internal air duct; and
an external air outlet that allows air flow to exit the sensor housing.

16. The vehicle of claim 10, wherein
the sensor housing further comprises:
a sensor frame including a plurality of mounting points retaining the plurality of sensors; and
a sensor shell that covers the sensor frame and defines an exterior shape of the sensor housing, wherein
the sensor frame has a rigid structure that prevents movements of the plurality of sensors that disrupt acquisition and analysis of data of a surrounding environment during operation of the vehicle.

17. The vehicle of claim 16, wherein the sensor frame or the sensor shell is formed from Organo sheet technology.

18. The vehicle of claim 10, wherein the structural base is formed from Organo sheet technology.
